(19) United States
(12) Patent Application Publication
(10) Pub. No.: US 2024/0359586 A1
(43) Pub. Date: Oct. 31, 2024

(54) METHOD FOR BIDIRECTIONAL ENERGY EXCHANGE BETWEEN AN ELECTRIC VEHICLE AND A CHARGING STATION, AND ARRANGEMENT

(71) Applicant: Volkswagen Aktiengesellschaft, Wolfsburg (DE)

(72) Inventors: Henrik SCHWARZE, Magdeburg (DE); Lars BAUMANN, Braunschweig (DE)

(73) Assignee: Volkswagen Aktiengesellschaft, Wolfsburg (DE)

(21) Appl. No.: 18/649,858

(22) Filed: Apr. 29, 2024

(30) Foreign Application Priority Data
Apr. 28, 2023 (DE) 10 2023 203 953.2

(51) Int. Cl. B60L 53/66; B60L 53/62; B60L 53/63; B60L 55/00

(52) U.S. Cl. CPC B60L 53/66; B60L 53/62; B60L 53/63; B60L 55/00

(57) ABSTRACT

A method for bidirectional energy exchange between an electric vehicle and a charging station. By use of a value-added service of the ISO 15118-2 communication protocol, at least one parameter and/or command concerning discharging or charging of an energy store of an energy unit of the electric vehicle are/is transferred between the energy unit and the charging station and/or between the charging station and the energy unit. The charging station carries out the discharging or charging taking into account the at least one transferred parameter and/or command. An arrangement for performing the method is also provided.

This nonprovisional application claims priority under 35 U.S.C. § 119(a) to German Patent Application No. 10 2023 203 953.2, which was filed in Germany on Apr. 28, 2023, and which is herein incorporated by reference.

### BACKGROUND OF THE INVENTION

### Field of the Invention

The invention relates to a method for bidirectional energy exchange between an electric vehicle and a charging station, and to an arrangement.

### Description of the Background Art

The energy stores of electric vehicles must be charged at charging stations. In principle, there is also an option to feed electrical energy from the energy store of the electric vehicle into a supply network via the charging station. However, bidirectional charging (or discharging) is not possible according to the ISO 15118-2 communication protocol. The communication protocol provides value-added services (VASs), which may have any given design.

### SUMMARY OF THE INVENTION

It is therefore an object of the invention to provide a method for bidirectional energy exchange between an electric vehicle and a charging station, and an arrangement for same.

In an example, a method is provided for bidirectional energy exchange between an electric vehicle and a charging station is provided, wherein by use of a value-added service of the ISO 15118-2 communication protocol (according to the current version as of the filing date), at least one parameter and/or command concerning discharging or charging of an energy store of an energy unit of the electric vehicle are/is transferred between the energy unit and the charging station and/or between the charging station and the energy unit, the charging station carrying out the discharging or charging, taking into account the at least one transferred parameter and/or command.

In addition, in particular an arrangement is provided, comprising an energy unit for an electric vehicle, a charging station, and an electrical connection that is established between the energy unit and the charging station, with a communication link according to the ISO 15118-2 communication protocol (according to the current version as of the filing date), wherein communication interfaces of the energy unit and of the charging station are configured to transfer, by use of a value-added service of the ISO 15118-2 communication protocol, at least one parameter and/or command concerning discharging or charging of an energy store of the energy unit between the energy unit and the charging station and/or between the charging station and the energy unit, the charging station being configured to carry out the discharging or charging of the energy store of the energy unit, taking into account the at least one transferred parameter and/or command.

The method and the arrangement allow a bidirectional energy exchange based on the ISO 15118-2 communication protocol. The bidirectional energy exchange is in particular a DC energy exchange; i.e., the energy exchange takes place by discharging or charging by use of a direct current. This is achieved by providing a value-added service (VAS) that is configured for this purpose. By use of the value-added service, at least one parameter and/or command concerning discharging or charging of an energy store of the energy unit of the electric vehicle are/is transferred between the energy unit and the charging station and/or between the charging station and the energy unit. In addition, the charging station is configured to carry out the discharging or charging of the energy store of the energy unit of the electric vehicle, taking into account the at least one transferred parameter and/or command. The method and the arrangement in particular allow an exchange of parameters that specify and/or determine the boundary conditions of a bidirectional energy exchange, in particular a DC energy exchange, so that such an energy exchange can take place in particular from the energy unit to the charging station (or from the charging station to the energy unit of the electric vehicle) in a coordinated manner, even using the ISO 15118-2 communication protocol, which is not configured for this purpose.

The terms “discharging” and “charging” can be used in particular with reference to the energy store.

The value-added service can be designed according to a representational state transfer (REST) interface. The provided services define a client-server architecture between the energy unit and the charging station, a data exchange taking place in a stateless manner. The communication interface of the charging station implements in particular the server, while the communication interface of the energy unit of the electric vehicle implements in particular the client. Any data exchange is initiated in particular by the energy unit of the electric vehicle.

All defined services of the value-addedservice can be implemented, for example, in the form of a vehicle-to-grid (V2G) service, and in particular are part of an existing High Level Communication (HLC) session in the V2G protocol as defined according to ISO 15118-2. The services are activated in particular after the HLC session has been started, and are concluded when the HLC session is stopped.

The at least one command can involve a request for the bidirectional energy exchange. A bidirectional energy exchange may thus be initiated after a connection is established between the electric vehicle and the charging station via the ISO 15118-2 communication protocol.

The at least one parameter can involve at least one present limit value concerning the discharging or charging of the energy store of the electric vehicle. In particular, a value range may thus be predefined, within which a (bidirectional) energy exchange may and/or is to take place.

The at least one parameter and/or command can be regularly re-determined and/or re-transferred after a predefined time period elapses. Present values for the at least one parameter, for example present limit values, may thus be transferred, in particular also during the energy exchange, so that an altered state of the energy unit and/or an altered state of the charging station may thus be taken into account while the energy exchange is taking place.

The charging station can also transfer a connection status to the energy unit, the connection status involving information concerning whether or not the charging station is connected to a supply network at the present point in time. In this way, the energy unit may be informed as to whether or not an energy exchange with the supply network is basically possible. The connection status encompasses the two states “connected” and “not connected,” for example. Furthermore, the connection status may also involve stepped values, which for example may encode an extent or an available power during a possible energy exchange with the supply network.

An energy store of the energy unit may be cyclically discharged and recharged within a bidirectionally chargeable and dischargeable state of charge range. In this way, the energy store, as an intermediate store of electrical energy, may be incorporated into a larger supply infrastructure. If the energy store of the energy unit of the electric vehicle is not needed, it is thus possible to create and provide additional capacity for intermediate storage of electrical energy, for example to temporarily store and keep ready sustainably generated electrical energy for time periods in which little or no renewable energy generation is possible. For this purpose, the cyclical discharging and charging may in particular also be carried out repeatedly.

The at least one parameter that is transferred from the energy unit to the charging station can include at least one of the following variables, which in particular form limit values: a minimum charging voltage, a minimum charging current, a maximum charging current, a minimum charging capacity, a maximum charging capacity, a minimum discharging current, a maximum discharging current, a minimum discharging capacity, a maximum discharging capacity, a quantity of energy for reaching a target state of charge, a quantity of energy for reaching a minimum state of charge, a quantity of energy for reaching a maximum state of charge, a quantity of energy that is available for discharging until a predefined state of charge range (minimum state of charge/SOC to maximum state of charge/SOC) for the cyclical discharging and charging is departed from, a quantity of energy that is to be charged until a predefined state of charge range for the cyclical discharging and charging is reached, and a target state of charge. By use of these variables, the discharging and charging may be controlled in particular in a targeted manner.

The at least one parameter that is transferred from the charging station to the energy unit can include at least one of the following variables, which in particular form limit values: a minimum possible discharging current of the charging station, a maximum possible discharging current of the charging station, and a maximum possible discharging capacity of the charging station. By use of these variables, in particular the discharging of the energy store and feeding into a supply network may be controlled in a targeted manner.

Before the at least one parameter and/or command are/is transferred on the vehicle side, an availability of the value-added service and/or a version of the value-added service for the charging station are/is queried, the transfer taking place only when the value-added service is provided and/or a predefined version can be provided. In this way, a charging station may be checked for the presence of, and suitability for, bidirectional energy exchange by use of the value-added service.

The bidirectional energy exchange can be ended when at least one termination condition is met. Such a termination condition may be, for example, a corresponding command for ending the energy exchange, which may be triggered by a battery controller, a vehicle controller, and/or a user. In addition, a termination condition may be the reaching of a predefined time of vehicle departure. Furthermore, the termination condition may also be predefined and checked based on the at least one parameter, for example based on a target state of charge for the energy store.

Further features for configuring the arrangement result from the description of the examples of the method. The advantages of the arrangement are in each case the same as for the examples of the method.

Further scope of applicability of the present invention will become apparent from the detailed description given hereinafter. However, it should be understood that the detailed description and specific examples, while indicating preferred embodiments of the invention, are given by way of illustration only, since various changes, modifications, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of an arrangement; and

FIG. 2 shows a schematic flow chart of an example of the method for bidirectional energy exchange between an electric vehicle and a charging station.

### DETAILED DESCRIPTION

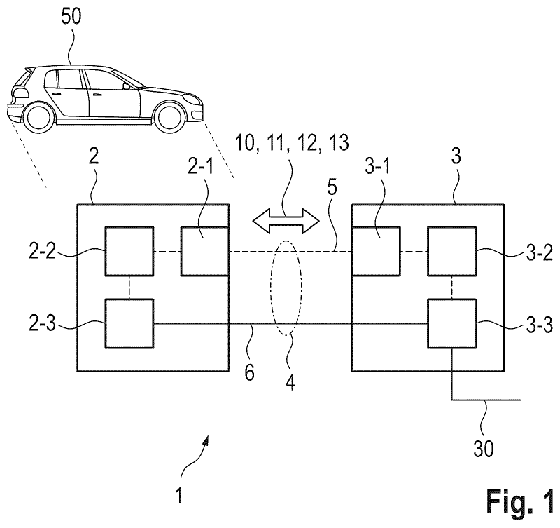

FIG. 1 shows a schematic illustration of an example of the arrangement 1. The arrangement 1 is configured in particular to carry out the method described in the present disclosure. The arrangement 1 comprises an energy unit 2 for an electric vehicle 50, a charging station 3, an electrical connection 4, provided between the energy unit 2 and the charging station 3, with a communication link 5 according to the ISO 15118-2 communication protocol, and a high-voltage connection 6 (in particular a DC high-voltage connection). The energy unit 2 is situated in the electric vehicle 50, and for example supplies power to a traction drive of the electric vehicle 50.

The energy unit 2 has a communication interface 2-1, a control device 2-2, and an electrical energy store 2-3, which is designed in particular as a high-voltage battery. In addition, the energy unit 2 may include a converter, which is not illustrated for reasons of clarity.

The charging station 3 has a communication interface 3-1, a control device 3-2, and a connection 3-3 to a supply network 30. In addition, the charging station 3 may include a converter, which is not illustrated for reasons of clarity.

The communication interfaces 2-1, 3-1 of the energy unit 2 and of the charging station 3, respectively, are configured to transfer, by use of a value-added service of the ISO 15118-2 communication protocol, at least one parameter 10 and/or command 11, concerning discharging or charging of an energy store 2-3 of the energy unit 2, between the energy unit 2 and the charging station 3 and/or between the charging station 3 and the energy unit 2.

The control devices 2-2, 3-2 are configured in particular to control and/or regulate the charging and discharging (with reference to the energy store 2-3), and for this purpose to communicate with one another via the communication interfaces 2-1, 3-1. For this purpose, the control devices 2-2, 2-3 each include, for example, a computer (not shown) and a memory (not shown).

The charging station 3 is configured to carry out the discharging or charging of the energy store 2-3 of the energy unit 2, taking into account the at least one transferred parameter 10 and/or command 11.

It may be provided that the at least one command 11 involves a request for the bidirectional energy exchange.

It may be provided that the at least one parameter 10 involves at least one present limit value 12 concerning the discharging or charging of the energy store 2-3 of the electric vehicle 50.

It may be provided that the at least one parameter 10 and/or command 11 are/is regularly re-determined and/or re-transferred after a predefined time period elapses. The predefined time period may be in the range of one to several seconds, for example.

It may be provided that the charging station 3 also transfers a connection status 13 to the energy unit 2, the connection status 13 involving information concerning whether or not the charging station 3 is connected to the supply network 30 at the present point in time.

It may be provided that the energy store 2-3 of the energy unit 2 is cyclically discharged and recharged within a bidirectionally chargeable and dischargeable state of charge range.

It may be provided that the at least one parameter 10 that is transferred from the energy unit 2 to the charging station 3 includes at least one of the following variables, which in particular form limit values: a minimum charging voltage, a minimum charging current, a maximum charging current, a minimum charging capacity, a maximum charging capacity, a minimum discharging current, a maximum discharging current, a minimum discharging capacity, a maximum discharging capacity, a quantity of energy for reaching a target state of charge, a quantity of energy for reaching a minimum state of charge, a quantity of energy for reaching a maximum state of charge, a quantity of energy that is available for discharging until a predefined state of charge range for the cyclical discharging and charging is departed from, a quantity of energy that is to be charged until a predefined state of charge range for the cyclical discharging and charging is reached, and a target state of charge.

It may be provided that the at least one parameter 10 that is transferred from the charging station 3 to the energy unit 2 includes at least one of the following variables, which in particular form limit values: a minimum possible discharging current of the charging station, a maximum possible discharging current of the charging station, and a maximum possible discharging capacity of the charging station.

It may be provided that before the at least one parameter 10 and/or command 11 are/is transferred on the vehicle side, an availability of the value-added service and/or a version of the value-added service for the charging station 3 are/is queried, the transfer taking place only when the value-added service is provided and/or a predefined version can be provided.

It may be provided that the bidirectional energy exchange is ended when at least one termination condition is met. Such a termination condition may be, for example, a corresponding command for ending the energy exchange, which may be triggered by a battery controller, a vehicle controller, and/or a user. In addition, a termination condition may be the reaching of a predefined time of vehicle departure, or may also be predefined and checked based on the at least one parameter, for example based on a target state of charge for the energy store

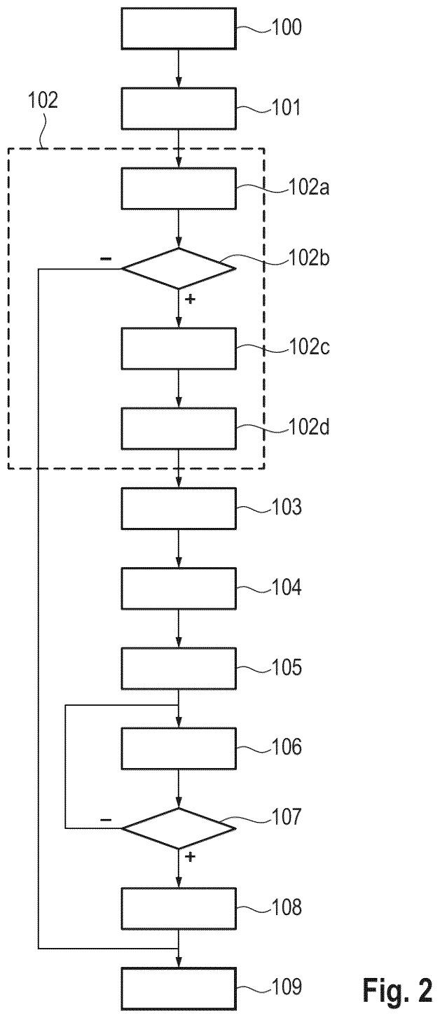

FIG. 2 shows a schematic flow chart of an example of the method for bidirectional energy exchange between an electric vehicle and a charging station, for example a Wallbox.

A charging station is connected to an energy unit of an electric vehicle in a method step 100. This takes place in a manner known per se, using a charging cable. In the course of the connection, a physical communication link is also established. This may take place in a wired or wireless manner (for example, via Control Pilot (CP), Proximity Pilot (PP), Power Line Communication (PCL), Controller Area Network (CAN), WLAN, etc.).

A communication according to the ISO 15118-2 communication protocol is started in a method step 101.

It is checked in a method step 102 whether the energy unit of the electric vehicle and the charging station are using the same value-added service for a bidirectional energy exchange. For this purpose, in a method step 102a the charging station reports to the energy unit that the value-added service is supported for bidirectional energy exchange. In addition, a version number of the value-added service is transferred. In a method step 102b the energy unit checks whether the same version is supported. If this is not the case, the value-added service is not started, and the normal ISO 15118-2 communication is continued in a method step 109. However, if this is the case, in a method step 102c the value-added service is reserved by the energy unit at the charging station. The value-added service is authorized by the charging station in a method step 102d.

In a method step 103, at least one parameter and/or command concerning discharging or charging of the energy store of the energy unit of the electric vehicle are/is transferred between the energy unit and the charging station and/or between the charging station and the energy unit. In particular, it is provided that the at least one parameter involves at least one present limit value concerning the discharging or charging of the energy store of the electric vehicle. In particular, multiple present limit values are transferred.

In particular, it may be provided that the at least one parameter that is transferred from the energy unit to the charging station includes at least one of the following variables, which in particular form limit values: a minimum charging voltage, a minimum charging current, a maximum charging current, a minimum charging capacity, a maximum charging capacity, a minimum discharging current, a maximum discharging current, a minimum discharging capacity, a maximum discharging capacity, a quantity of energy for reaching a target state of charge, a quantity of energy for reaching a minimum state of charge, a quantity of energy for reaching a maximum state of charge, a quantity of energy that is available for discharging until a predefined state of charge range for the cyclical discharging and charging is departed from, a quantity of energy that is to be charged until a predefined state of charge range for the cyclical discharging and charging is reached, and a target state of charge.

Furthermore, it may be provided in particular that the at least one parameter that is transferred from the charging station to the energy unit includes at least one of the following variables, which in particular form limit values: a minimum possible discharging current of the charging station, a maximum possible discharging current of the charging station, and a maximum possible discharging capacity of the charging station.

The energy unit requests the bidirectional energy exchange by means of a command in a method step 104. This activates the bidirectional energy exchange.

The charging station starts the charging or discharging of the energy store of the energy unit of the electric vehicle within the predefined present limit values in a method step 105. For this purpose, in particular a converter, in particular an AC/DC converter and/or a DC/AC converter, of the charging station may be appropriately activated. In addition, a converter of the energy unit may be appropriately activated.

For example, discharging of the energy store may take place at a maximum discharging current. Alternatively, charging of the energy store may take place at a maximum charging current. Further parameters or limit values that may be transferred and taken into account have been listed above.

During the charging or discharging, present limit values are re-determined and re-transferred in each case in a method step 106. It is provided that the present limit values are regularly re-determined and/or re-transferred after a predefined time period elapses.

It is checked in method step 107 whether at least one termination condition is met. Such a termination condition may be, for example, a corresponding command for ending the energy exchange, which may be triggered by a battery controller, a vehicle controller, and/or a user. In addition, a termination condition may be the reaching of a predefined time of vehicle departure. Furthermore, the termination condition may also be predefined and checked based on the at least one parameter, for example based on a target state of charge for the energy store.

If the check shows that the at least one termination condition is not present, a skip is made to method step 106. However, if the check shows that the at least one termination condition is present, the value-added service is ended in a method step 108.

After the value-added service is ended, a change is made back to the normal ISO 15118-2 communication in a method step 109.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for bidirectional energy exchange between an electric vehicle and a charging station, the method comprising:
transferring, via a value-added service of the ISO 15118-2 communication protocol, at least one parameter and/or command concerning discharging or charging of an energy store of an energy unit of the electric vehicle between the energy unit and the charging station and/or between the charging station and the energy unit;
performing, via the charging station, a discharging or charging based on the at least one transferred parameter and/or command.

2. The method according to claim 1, wherein the at least one command involves a request for the bidirectional energy exchange.

3. The method according to claim 1, wherein the at least one parameter involves at least one present limit value concerning the discharging or charging of the energy store of the electric vehicle.

4. The method according to claim 1, wherein the at least one parameter and/or command is regularly re-determined and/or re-transferred after a predefined time period elapses.

5. The method according to claim 1, wherein the charging station also transfers a connection status to the energy unit, the connection status involving information concerning whether or not the charging station is connected to a supply network at the present point in time.

6. The method according to claim 1, wherein the energy store of the energy unit is cyclically discharged and recharged within a bidirectionally chargeable and dischargeable state of charge range.

7. The method according to claim 1, wherein the at least one parameter that is transferred from the energy unit to the charging station comprises at least one of the following variables:
a minimum charging voltage;
a minimum charging current;
a maximum charging current;
a minimum charging capacity;
a maximum charging capacity;
a minimum discharging current;
a maximum discharging current;
a minimum discharging capacity;
a maximum discharging capacity;
a quantity of energy for reaching a target state of charge;
a quantity of energy for reaching a minimum state of charge;
a quantity of energy for reaching a maximum state of charge;
a quantity of energy that is available for discharging until a predefined state of charge range for the cyclical discharging and charging is departed from;
a quantity of energy that is to be charged until a predefined state of charge range for the cyclical discharging and charging is reached; and/or
a target state of charge.

8. The method according to claim 1, wherein the at least one parameter that is transferred from the charging station to the energy unit comprises at least one of the following variables:
a minimum possible discharging current of the charging station;
a maximum possible discharging current of the charging station; and/or
a maximum possible discharging capacity of the charging station.

9. The method according to claim 1, wherein, before the at least one parameter and/or command are transferred on the vehicle side, an availability of the value-added service and/or a version of the value-added service for the charging station is queried, the transfer taking place only when the value-added service is provided and/or a predefined version can be provided.

10. An arrangement comprising:
an energy unit for an electric vehicle;
a charging station; and
an electrical connection that is established between the energy unit and the charging station, with a communication link according to the ISO 15118-2 communication protocol,
wherein communication interfaces of the energy unit and of the charging station are configured to transfer, by use of a value-added service of the ISO 15118-2 communication protocol, at least one parameter and/or command concerning discharging or charging of an energy store of the energy unit between the energy unit and the charging station and/or between the charging station and the energy unit, and
wherein the charging station is configured to carry out the discharging or charging of the energy store of the energy unit, taking into account the at least one transferred parameter and/or command.
